(19) United States
(12) Patent Application Publication
(10) Pub. No.: US 2014/0030163 A1
(43) Pub. Date: Jan. 30, 2014

(54) PRODUCT OF CHROMIUM OXIDE, ZIRCONIUM OXIDE AND HAFNIUM OXIDE

(71) Applicants: Christian His, Cavaillon (FR); Franceline Villermaux, Avignon (FR); Thibault Champion, Maubec (FR); Nicolas Raffin, Le Thor (FR); Laurie San Miguel, Althen Des Paluds (FR)

(72) Inventors: Christian His, Cavaillon (FR); Franceline Villermaux, Avignon (FR); Thibault Champion, Maubec (FR); Nicolas Raffin, Le Thor (FR); Laurie San Miguel, Althen Des Paluds (FR)

(73) Assignee: SAINT-GOBAIN CENTRE DE RECHERCHES ET D'ETUDES EUROPEEN, Courbevoie (FR)

(21) Appl. No.: 14/111,337

(22) PCT Filed: Apr. 13, 2012
(86) PCT No.: PCT/IB12/51848

§ 371 Date: Oct. 11, 2013

(30) Foreign Application Priority Data
Apr. 15, 2011 (FR) 11 53308
Dec. 23, 2011 (FR) 11 62379

(51) Int. Cl. C04B 35/12; C04B 35/49; C04B 35/10; C10J 3/72

(52) U.S. Cl. CPC C04B 35/12; C10J 3/72; C04B 35/49; C04B 35/10
USPC 422/241; 501/103; 501/104; 501/105

(57) ABSTRACT

Sintered refractory product including, in percentages by weight on the basis of the oxides, —more than 10% of chromium oxide Cr₂O₃, —more than 2% of hafnium oxide HfO₂, —more than 1% of zirconium oxide ZrO₂, the total content of chromium, hafnium and zirconium oxides Cr₂O₃+HfO₂+ZrO₂ being greater than 70%.

### TECHNICAL FIELD

The invention relates to a refractory product comprising chromium oxide, used especially as an inner coating for a gasification reactor or “gasifier”.

### PRIOR ART

A gasifier used for gasifying coal is known in particular. The process for gasifying coal, which has been known for about fifty years, is currently undergoing substantial development. The reason for this is that it makes it possible, from very diverse hydrocarbon-based materials, for example coal, petroleum coke, biomass, wood, wood charcoal, or even heavy oils to be recycled, to produce synthesis gases that serve, firstly, as a source of clean energy, and, secondly, as base compounds for the chemical industry. This process also makes it possible to remove the unwanted components, for example NOx, sulfur or mercury, before any discharge into the atmosphere.

The principle of gasification consists of a controlled partial combustion, under pressure and in the presence of water vapor or oxygen, at a temperature between about 1000 and 1600° C.

Various types of gasifier exist, with a fixed, fluidized or entrained bed. These gasifiers differ by the mode of introduction of the reagents, the manner in which the oxidant-fuel mixing is performed, the temperature and pressure conditions and the process for removing the ash or the liquid residual slag resulting from the reaction.

The article entitled “Refractories for Gasification” published in the review Refractories Applications and News, Volume 8, Number 4, July-August 2003, written by Wade Taber of the Energy Systems Department of Saint-Gobain Industrial Ceramics Division, describes the structure of an inner refractory coating of a gasifier. This gasifier is coated with different layers of refractory products that are capable of withstanding the temperature, pressure and chemical environment conditions to which they are subjected during gasification. The layers of refractory products thus protect the inner metal wall of the gasifier against heat and corrosion by the gases and the slags.

The composition of the slags in gasifiers typically consists of SiO₂, FeO or Fe₂O₃, CaO and d′Al₂O₃. It may also comprise other oxides derived from the products feeding the gasifier. The basicity index B=(CaO+MgO+Fe₂O₃)/(Al₂O₃+SiO₂) is typically about 0.6 and the ratio C/S=CaO/SiO₂ is typically 0.4, the contents being in mass percentages.

To increase the service life of refractory coatings, subjected to corrosion by slags and to the heating cycle, researchers have attempted to increase their thickness. However, this solution has the drawback of reducing the working volume of the gasifier and thus its yield.

James P. Bennett, in the article “Refractory liner used in slagging gasifiers” published in the review Refractories Applications and News Vol. 9 Number 5 September/October 2004, pages 20-25, explains that the service life of the current refractory coatings of gasifiers, in particular of air-cooled systems, is very limited despite their high content of chromium oxide. He especially mentions the report by S. J. Clayton, G. J. Stiegel and J. G. Wimer “Gasification Technologies, Gasification Markets and Technologies—Present and Future, an industry Perspective”, US DOE report DOE/FE 0447 July 2002.

FR 2 883 282 describes an inner refractory coating for a gasifier having at least one region made of a sintered material comprising, as mass percentages, at least 40% of chromium oxide (Cr₂O₃) and at least 1% of zirconium oxide (ZrO₂), at least 20% by mass of said zirconium oxide (ZrO₂) being stabilized in cubic and/or quadratic form. This coating thus has better corrosion resistance.

WO 2008 109222 proposes a treatment for protecting refractory products constituting the refractory coating of gasifiers.

There is an ongoing need for a refractory product that is capable of withstanding, more efficiently and durably than the known products, the heat shocks encountered inside gasifiers and, preferably, which shows better resistance to corrosion by slags.

The aim of the invention is to satisfy this need.

### SUMMARY OF THE INVENTION

According to the invention, this aim is achieved by means of a sintered refractory product comprising, as mass percentages, more than 10% chromium oxide (Cr₂O₃), more than 2% hafnium oxide (HfO₂), more than 1% zirconium oxide (ZrO₂), the total content of chromium, hafnium and zirconium oxides (Cr₂O₃+HfO₂+ZrO₂) being greater than 70%.

As will be seen in greater detail in the description hereinbelow, surprisingly, the presence of hafnium oxide makes it possible to improve the resistance to heat shocks and also to conserve or even improve the resistance to infiltration and to attack by slags.

A product according to the invention may also have one or more of the following optional characteristics:
The content of hafnium oxide (HfO₂) in the product is greater than 2.5%, or even greater than 3%, or even greater than 4%, as mass percentages.
Preferably, the content of hafnium oxide (HfO₂) in the product is less than 50%, or even less than 40%, or even less than 30%, or even less than 20%, or even less than 15%, or even less than 10%, or even less than 7%, or even less than 5%, as mass percentages.
In one embodiment, more than 50%, more than 75%, or even more than 90% of the hafnium oxide of the product is contained in the matrix, as a mass percentage.
Preferably, the content of chromium oxide (Cr₂O₃) is greater than 20%, or even greater than 30%, or even greater than 45%, or even greater than 50%, or even greater than 60%, greater than 65%, and/or less than 95%, as mass percentages.
Preferably, the content of zirconium oxide (ZrO₂) is greater than 4.5%, or even greater than 6%, or even greater than 8%, or even greater than 10%, or even greater than 15%, and/or less than 50%, less than 40%, as mass percentages.
Preferably, more than 20%, more than 30%, more than 40%, more than 50%, more than 60% of the zirconium oxide, as a mass percentage, is stabilized in cubic and/or quadratic (or “tetragonal”) form.
The only zirconium oxide present in the matrix preferably represents more than 2.5% of the total mass of the product.
The total content of chromium, hafnium and zirconium oxides (Cr₂O₃+HfO₂+ZrO₂) is greater than 80%, greater than 85%, greater than 90%, as a mass percentage.
Preferably, said product comprises at least one dopant, optionally acting as a stabilizer for the zirconium oxide, chosen from CaO, MgO, Y₂O₃ TiO₂, and mixtures thereof, preferably CaO and/or Y₂O₃, preferably Y₂O₃.
The content of calcium oxide (CaO) is less than 4.0%, or even less than 3.0%, or even less than 2.0%, or even less than 1.0%, as mass percentages.
The content of magnesium oxide (MgO) is less than 4.0%, or even less than 3.0%, or even less than 2.0%, or even less than 1.0%, as mass percentages.
The content of yttrium oxide (Y₂O₃) is less than 4.0%, or even less than 3.0%, or even less than 2.0%, as mass percentages.
The content of yttrium oxide (Y₂O₃) in the product is greater than 0.3%, preferably greater than 0.5%, preferably greater than 0.7%, as mass percentages.
The content of titanium oxide (TiO₂) is less than 4.0%, or even less than 3.0%, or even less than 2.0%, or even less than 1.0%, as mass percentages.
Preferably, the sum of the contents of calcium, magnesium, yttrium and titanium oxides (CaO+MgO+Y₂O₃+TiO₂) is less than 6.0%, or even less than 5.0%, or even less than 4.0%, or even less than 3.0%, and/or greater than 0.5%, greater than 1.0%, or even greater than 2.0%, as mass percentages.
Preferably also, the dopant acts, at least partially, as a stabilizer for the zirconium oxide.
In one embodiment, more than 50%, more than 75%, or even more than 90%, more than 95%, or even substantially 100% of the dopant, in particular of the calcium oxide and/or the yttrium oxide, is contained in the matrix, as a mass percentage.
Preferably, the content of aluminum oxide (Al₂O₃) is greater than 1%, or even greater than 1.5%, and/or less than 20%, or even less than 10%, or even less than 8%, or even less than 5%, as mass percentages.
Preferably, the content of silicon oxide (SiO₂) is greater than 0.5%, or even greater than 0.7%, or even greater than 1%, and/or less than 3%, preferably less than 1.5%, as mass percentages.
Preferably, the sum of the contents of chromium oxide (Cr₂O₃), zirconium oxide (ZrO₂), hafnium oxide (HfO₂), aluminum oxide (Al₂O₃), silicon oxide (SiO₂), calcium oxide (CaO), magnesium oxide (MgO), yttrium oxide (Y₂O₃) and titanium oxide (TiO₂) is greater than 95%, preferably greater than 98%, as mass percentages, the other constituents of the product preferably being impurities. The impurities conventionally comprise iron, predominantly in Fe₂O₃ form, and alkali metal oxides such as Na₂O and K₂O. It is considered that such contents of impurities do not call into doubt the advantages afforded by the invention.
Preferably, the oxides represent more than 90%, more than 95%, more than 99%, or even substantially 100% of the mass of the product.
The open porosity of the product is greater than 5%, greater than 8%, greater than 10% and/or less than 25%, less than 20%, or even less than 15%.
The product is in the form of a layer applied to the inner wall of a gasifier reactor or in the form of an assembly of blocks arranged to protect said wall. Preferably, all the layer or all the blocks of the assembly consist of a product according to the invention.

Surprisingly, the inventors have also found that a product according to the invention may have noteworthy corrosion resistance.

Preferably, the granulate represents more than 60%, more than 70%, and/or less than 90%, or less than 80% of the mass of the product, the remainder to 100% consisting of the matrix.

According to one embodiment, the structure of the product contains a granulate consisting, for more than 90%, or even more than 95%, or even more than 97% of its mass, of chromium oxide, said granulate being bound by a matrix consisting, for more than 90%, or even more than 94% of its mass,
of hafnium oxide and
of zirconium oxide and/or chromium oxide and/or aluminum oxide, and optionally of a dopant chosen from CaO, MgO, Y₂O₃, TiO₂, and mixtures thereof, the dopant optionally acting as a stabilizer for the zirconium oxide.

In particular, the dopant may be CaO and/or Y₂O₃, preferably Y₂O₃.

According to another embodiment, the structure of the product contains a granulate consisting, for more than 90%, more than 95%, or even more than 97% of its mass, of zirconium oxide and/or hafnium oxide and/or chromium oxide, said granulate being bound by a matrix consisting, for more than 90%, or even more than 94% of its mass, of zirconium oxide and/or chromium oxide and/or aluminum oxide, and optionally of hafnium oxide and optionally of a dopant chosen from CaO, MgO, Y₂O₃, TiO₂, and mixtures thereof, the dopant optionally acting as a stabilizer for the zirconium oxide. In particular, the dopant may be CaO and/or Y₂O₃, preferably Y₂O₃.

According to another embodiment, the structure of the product contains a granulate consisting, for more than 90%, more than 95%, or even more than 97% of its mass, of zirconium oxide and/or hafnium oxide and/or chromium oxide, said granulate being bound by a matrix consisting, for more than 80%, or even more than 90% of its mass, of hafnium oxide and zirconium oxide doped with CaO and/or Y₂O₃ and optionally of chromium oxide.

Preferably, the content of Al₂O₃ in the matrix is greater than 1%, or even greater than 1.5%, and/or less than 10%, or even less than 8%, or even less than 5%, as a mass percentage on the basis of the mass of the oxides of the product.

Preferably, the matrix comprises at least 1.5% hafnium oxide, as a mass percentage on the basis of the mass of the oxides of the product.

The invention also relates to a gasifier comprising a reactor provided with an inner wall which is coated, at least partially, with a refractory coating comprising a refractory product according to the invention, or even consisting of such products.

Said refractory product may be in the form of a layer or in the form of a block.

The invention also relates to a preform which is adapted to lead, by sintering, to a sintered refractory product according to the invention, and a particulate mixture which is adapted to lead, by forming, to a preform according to the invention.

Finally, the invention relates to a manufacturing process comprising the following successive steps:
a) preparation of a feedstock,
b) pouring of said feedstock into a mold and forming, for example by vibration and/or pressing and/or hammering of said feedstock inside the mold, so as to form a preform,
c) removing the preform from the mold,
d) preferably, drying of the preform, preferably in air or in an atmosphere of controlled humidity, preferably such that the residual humidity of the preform is between 0 and 0.5%,
e) baking of the preform, preferably under an oxidizing atmosphere, at a temperature of between 1300 and 1600° C. so as to form a sintered refractory product.

According to the invention, the feedstock is adapted to lead, at the end of step e), to a sintered refractory product according to the invention.

The sources of zirconium oxide may contain hafnium oxide, conventionally less than 2% hafnium oxide.

According to the invention, hafnium oxide is preferably added to the feedstock from the source of hafnium oxide comprising more than 50%, more than 75%, more than 90%, or even substantially 100% hafnium oxide. For example, a powder of hafnium oxide particles is added. Preferably, the hafnium oxide provided by the source of zirconium oxide is then taken into account.

### Definitions

The term “preform” conventionally means an assembly of particles bound by means of a binder, which is generally temporary, and whose microstructure changes in the course of sintering. A preform may especially have the form of a block or a layer, for example sprayed onto a wall of a reactor.

The term “particle” means a solid object within a powder, or “particulate mixture”. A distinction is made in particular between particles having a size greater than 150 μm, known as “grains”, and those having a size of less than or equal to 150 μm, known as “fine particles” or “matrix particles”. All the grains together constitute the “granulate”. All the matrix particles together constitute the “matrix fraction”.

By extension, the terms “granulate” and “matrix fraction” also refer to the grains and matrix particles after they have been fastened together in the form of a preform. The “granulate” also denotes the grains bound by the matrix after sintering.

The term “particulate mixture” means a dry mixture of particles (not bound together).

The term “size” of a particle means the average of its largest dimension dM and of its smallest dimension dm: (dM+dm)/2. The particle size of a particulate mixture is conventionally evaluated by a particle size distribution characterization formed using a laser granulometer. The laser granulometer may be, for example, a Partica LA-950 machine from the company Horiba.

The percentiles or “centiles” 10 (D₁₀), 50 (D₅₀), 90 (D₉₀) and 99.5 (D_{99.5}) of a powder are the particle sizes corresponding to the mass percentages of 10%, 50%, 90% and 99.5%, respectively, on the cumulative particle size distribution curve of the particles of the powder, the particle sizes being classified in increasing order. For example, 10% by mass of the particles of the powder have a size less than D₁₀ and 90% by mass of the particles have a size greater than D₁₀. The percentiles may also be evaluated by means of a particle size distribution performed using a laser granulometer.

The term “maximum size” refers to the percentile 99.5 (D_{99.5}) of said powder.

The term “median size” of a powder refers to the percentile D₅₀, i.e. the size dividing the particles of a first and second population that are equal in mass, these first and second populations comprising only particles having a larger or smaller size, respectively, than the median size.

The term “block” means a solid object obtained by molding a feedstock comprising a particulate mixture (unlike a coating layer).

The term “matrix” means a crystalline or noncrystalline phase, which provides a continuous structure between the grains and is obtained during sintering from the matrix fraction.

The term “sintering” refers to a heat treatment via which refractory particles of a preform become transformed to form a matrix binding together other particles of said preform.

The term “refractory product” means a product having a melting point or dissociation point of greater than 1000° C.

The term “impurities” means the inevitable constituents, unintentionally and necessarily introduced with the starting materials or resulting from reactions with these constituents. The impurities are not necessary constituents, merely tolerated. Preferably, the mass amount of impurities is less than 2%, less than 1%, less than 0.5%, or even substantially zero.

The term “precursor” of a compound or of an element means a constituent that is capable of providing said compound, or said element, respectively, during the implementation of a manufacturing process according to the invention.

The oxide contents refer to overall contents for each of the corresponding chemical elements, expressed in the form of the most stable oxide, according to the usual convention in the industry.

Unless otherwise mentioned, all of the oxide contents of the products according to the invention are mass percentages expressed on the basis of the oxides.

The terms “containing a”, “comprising a” and “including a” mean “comprising at least one”, unless otherwise indicated.

### DETAILED DESCRIPTION

The sintered refractory product according to the invention consists of bound grains surrounded by the matrix.

The grains may have various chemical analyses, and in particular may comprise chromium oxide.

In particular, the granulate may consist, for more than 90%, or even more than 95%, or even more than 97% of its mass, of zirconium oxide and/or hafnium oxide and/or chromium oxide, in particular chromium oxide.

The matrix preferably comprises hafnium oxide. The only hafnium oxide present in the matrix preferably represents more than 1%, or even more than 2%, or even more than 3% of the total mass of the product.

The matrix preferably comprises zirconium oxide. The only zirconium oxide present in the matrix preferably represents more than 2.5%, or even more than 5%, or even more than 10% of the total mass of the product. The zirconium oxide may or may not be stabilized with a dopant.

In particular, the matrix may consist, for more than 90%, or even more than 94% of its mass, of zirconium oxide and/or hafnium oxide and/or chromium oxide and/or aluminum oxide, and optionally of a dopant chosen from CaO, MgO, Y₂O₃, TiO₂, and mixtures thereof, the dopant optionally acting as a stabilizer for the zirconium oxide. Preferably, the dopant is CaO and/or Y₂O₃, preferably Y₂O₃.

In one embodiment, the product comprises, as a mass percentage on the basis of the oxides, for a total of 100%:
60%<Cr₂O₃<80%,
2%<HfO₂<5%,
10%<ZrO₂<30%, preferably 15%<ZrO₂<25%,
preferably 0.3%<Y₂O₃<4%, preferably 0.5%<Y₂O₃,
Al₂O₃<8%, preferably Al₂O₃<5%, preferably Al₂O₃<4%,
preferably 1%<Al₂O₃, preferably 2%<Al₂O₃,
other oxides <10%, preferably other oxides <5%.

To manufacture a block made of a sintered refractory product according to the invention, use may be made of a process comprising steps a) to e) above.

Steps a) to e) are steps conventionally performed to manufacture sintered products.

In step a), a feedstock is prepared comprising:
a particulate mixture consisting of particles of the oxides intended to constitute the sintered refractory product and/or of the particles of precursors of these oxides,
optionally, one or more additives,
optionally, water.

The composition of the particulate mixture of the feedstock is determined as a function of the final composition of the block.

Preferably, the particulate mixture consists of more than 90%, more than 95%, or even substantially 100% by mass of particles with a size of less than 20 mm.

Preferably, the grains represent more than 60% and/or less than 90%, less than 80% of the mass of the particulate mixture, the remainder to 100% consisting of the matrix particles.

The method for determining the amounts of the oxides or oxide precursors in the feedstock is perfectly known to a person skilled in the art. In particular, a person skilled in the art knows that chromium, aluminum and zirconium oxides present in the starting feedstock are found in the manufactured refractory product. Certain oxides may also be provided by the additives. For a same amount of the constituents of the sintered refractory product, the composition of the starting feedstock may thus vary, especially as a function of the amounts and nature of the additives present in this feedstock.

The chromium oxide may be provided in the form of a mixture of sintered or molten particles of chromium oxide.

Preferably, the source of zirconium oxide comprises more than 80%, preferably more than 90% by mass of zirconium oxide.

The zirconium oxide may be provided in the form of a nonstabilized zirconium oxide and/or stabilized zirconium oxide powder. The zirconium oxide may be stabilized by means of a stabilizing dopant and/or by heat treatment at very high temperature (typically above 1700° C.). Preferably, at least 20% by mass of the zirconium oxide is stabilized in cubic and/or quadratic form. Preferably, the dopant is chosen from CaO, MgO, Y₂O₃, TiO₂, and mixtures thereof.

The zirconium oxide is preferably introduced, for more than 70%, more than 80%, more than 90%, or even substantially 100% of its mass, in the form of matrix particles.

In one embodiment, the zirconium oxide of the matrix fraction is provided in stabilized form by a dopant. Preferably, the zirconium oxide is doped to more than 3%, or even more than 4%, or even more than 5% with said dopant, as a mass percentage. The dopant is preferably Y₂O₃ and/or CaO.

The hafnium oxide may be provided, in part, by the source of zirconium oxide. Preferably, at least 1.5% by mass (on the basis of the mass of the particulate mixture) of a powder comprising, as a mass percentage, more than 70%, more than 80%, more than 90%, or even substantially 100% hafnium oxide is added.

The hafnium oxide is preferably introduced for more than 70%, more than 80%, more than 90%, or even substantially 100% of its mass, in the form of matrix particles.

The aluminum oxide may especially be provided in the form of a mixture of calcined or reactive alumina particles, or even white corundum.

In one embodiment, the yttrium oxide of the matrix fraction is provided by a powder comprising more than 80%, preferably more than 90%, or even more than 95% or substantially 100% by mass of yttrium oxide.

In a preferred embodiment, the yttrium oxide and/or the calcium oxide CaO of the matrix fraction are provided by the source of zirconium oxide.

The additives may be added to the feedstock to give it sufficient plasticity during the forming step b) and to give sufficient mechanical strength to the preform obtained at the end of steps c) and d). As examples of additives that may be used, which are well known to those skilled in the art, mention may be made in a nonlimiting manner of:
temporary organic binders (i.e. binders that are totally or partially removed during drying and baking steps), such as resins, cellulose or lignone derivatives, polyvinyl alcohols. Preferably, the amount of temporary binder is between 0.1% and 6% by mass relative to the mass of the particulate mixture of the feedstock;
forming agents such as magnesium or calcium stearates;
hydraulic binders such as a cement of CaO aluminate type;
deflocculants such as alkali metal polyphosphates or methacrylate derivatives;
sintering promoters such as titanium dioxide or magnesium hydroxide;
additives of clay type, which facilitate the processing and aid the sintering. These additives provide alumina and silicon oxide, and a few alkali metal or alkaline-earth metal oxides, or even iron oxide, depending on the type of clay.

The amounts of additives are not limiting. In particular, the amounts conventionally used in sintering processes are appropriate.

Preferably, the clay content in the starting feedstock is greater than 1.0%, greater than 1.5%, and/or less than 5.0%, less than 3.0%, as a mass percentage on the basis of the oxides.

Where appropriate, if an additive provides one or more of the oxides included in the composition of the refractory product, account will preferably be taken of this addition to determine the composition of the particulate mixture.

Preferably, the feedstock comprises, as a mass percentage:
more than 60% and preferably less than 90% of grains;
less than 40% of matrix particles;
less than 7% of one or more forming additives.

Preferably, the grains and the matrix particles together represent more than 94%, preferably more than 95% of the mass of the feedstock.

Mixing of the various constituents of the feedstock is continued until a substantially homogeneous mass is obtained.

Preferably, between 1% and 5% of water, as a mass percentage on the basis of the particulate mixture, is added.

The feedstock is preferably conditioned. Advantageously, it is thus ready to use.

The invention also relates to a particulate mixture as described above and to a feedstock prepared or liable to have been prepared during a step a).

In step b), the feedstock is placed in a mold and is then formed.

In the case of forming by pressing, a specific pressure of 400 to 800 kg/cm² is appropriate. Pressing is preferably performed uniaxially or isostatically, for example using a hydraulic press. It may advantageously be preceded by manual or pneumatic ramming and/or vibration.

In step c), the preform thus obtained is removed from the mold.

In step d), the drying may be performed at a moderately high temperature. Preferably, it is performed at a temperature of between 110 and 200° C. It conventionally lasts between 10 hours and one week depending on the format of the preform, until the residual humidity of the preform is less than 0.5%.

The invention also relates to a preform obtained in step c) or in step d).

In step e), the dried preform is baked. The baking time, between 3 and 15 days approximately from cold to cold, is variable as a function of the composition, but also of the size and shape of the preform. The baking cycle is preferably performed in a conventional manner, in air, at a temperature of between 1300° C. and 1600° C.

Preferably, the sintered refractory product obtained after step e) is in the form of a block with a mass of greater than 1 kg and/or for which all the dimensions are greater than 100 mm.

Surprisingly, the sintered refractory product obtained after step e) proved to be particularly resistant to the stresses encountered inside gasifier reactors, and especially resistant to infiltration by molten ash or slags.

The baking step e) may be performed, totally or partially, after assembly of the preform in the reactor.

The blocks are assembled by means of suitable expansion joints, according to techniques that are well known to those skilled in the art.

The manufacture of a product according to the invention is not limited to the process described above. In particular, the invention also relates to a refractory product according to the invention in the form of a coating on a reactor, especially a gasifier. To this end, a feedstock, for example manufactured according to step a) above, may be applied as a layer onto the inner surface of the wall of the reactor, for example by casting, vibrocasting or spraying, as a function of the needs and with great flexibility, and then sintered in situ during the preheating of the reactor, so as to produce a coating made of a refractory product according to the invention. The sintering preferably takes place at atmospheric pressure, preferably under an oxidizing atmosphere and preferably at a temperature of between 1300 and 1600° C.

In order not to unnecessarily emburden the present description, all the possible combinations according to the invention between the various embodiments are not reported. It is, however, clearly understood that all the possible combinations of the initial and/or preferred ranges and values described previously as regards the product, the matrix or the granulate, or the process, are envisioned.

### EXAMPLES

The examples that follow make it possible to illustrate the invention, in a nonexhaustive manner. For these examples, the following starting materials were used:
chromium oxide powder, with a purity of 98% Cr₂O₃ by mass, and consisting of at least 90% by mass of particles with a size of greater than 20 microns but less than 5 mm (powder G1),
powder of a ZrO₂—HfO₂ solid solution comprising 80% by mass of hafnium oxide and 20% by mass of zirconium oxide, and consisting of at least 90% by mass of particles with a size of greater than 20 microns but less than 5 mm (powder G2),
powder of corundum and of a ZrO₂—HfO₂ solid solution, comprising 40% by mass of hafnium oxide, 10% by mass of zirconium oxide and 50% by mass of alumina, and consisting of at least 90% by mass of particles with a size of greater than 20 microns but less than 5 mm (powder G3),
powder of zirconium oxide particles obtained by electrofusion and coated with a mixture comprising 80% by mass of hafnium oxide and 20% by mass of zirconium oxide, said coating constituting about 15% of the mass of the particles and at least 90% of said particles with a size of greater than 0.5 mm but less than 5 mm (powder G4),
powder of pigmentary chromium oxide (>98% Cr₂O₃), the median size (D₅₀) of which is less than 2 microns (powder P1),
powder of zirconium oxide (>98% by mass of ZrO₂) stabilized with 4% by mass of CaO, the size of the particles being less than 50 microns, the median size being about 12 μm, and said particles comprising about 70% zirconium oxide in quadratic and/or cubic form (powder P2),
alumina powder (>98% by mass of Al₂O₃), the median size (D₅₀) of which is less than 10 microns (powder P3),
hafnium oxide powder (>97% by mass of HfO₂), the median size (D₅₀) of which is less than 2 microns (powder P4),
zirconium oxide powder (>91% by mass of ZrO₂) stabilized with about 6% by mass of Y₂O₃, comprising about 70% zirconium oxide in quadratic and/or cubic form, as a mass percentage on the basis of the zirconia, the size of the particles being less than 50 microns (D₉₀=34 μm) with a median size of about 8 μm (powder P5a), or being less than 15 microns (D₉₀=8 μm) with a median size of about 3 μm (powder P5b), or being less than 5 microns with a median size of about 1 μm (powder P5c),
additives: clay RR40 with an alumina content of greater than 30%.

The test products were manufactured according to steps a) to e) described above.

In step a), the starting materials as indicated in table 1 were mixed with 1.3% to 2% of clay RR40 and about 3% of water and also 0.3% to 0.7% of binders (magnesium stearate and Bretax C) were added to the particulate mixture, as a percentage on the basis of said particulate mixture.

In step b) the feedstock inside the mold was compacted at a pressure of 600 kg/cm² so as to form a preform.

In step d) baking was performed in air at a temperature of between 1400 to 1600° C. so as to form a sintered refractory product.

Chemical analysis of the final sintered product was performed by X-ray fluorescence and is given in table 1.

The density and open porosity measurements were taken according to standard ISO 5017 on the products before any corrosion.

The change in the flexural modulus of rupture of products which have undergone a heat shock between 800° C. and 20° C. was evaluated according to standard ISO 5014. The value of the residual flexural modulus of rupture after a heat shock test is noted as “MOR res” and the loss of MOR (“MOR res” relative to the initial MOR measured at 20° C.) is noted as “Δ MOR” in table 1. The “MOR res” should be as high as possible. A lower “Δ MOR” (at least 20% as an absolute value) indicates great stability of the properties of the product.

The other measurements were performed on products subjected, after sintering, to corrosion representative of the service conditions to which the hot face of the gasifier coatings is subjected. This corrosion was obtained in the following manner. Specimens 25*25*180 mm³ in size of the test product, placed in an oven crucible, are immersed in a molten slag, at a temperature of 1600° C. for 4 hours under argon. The specimens are rotated at a speed of 2 rpm.

The slag used has the following mass composition:
SiO₂: about 30-50%
Al₂O₃: about 10-20%
Fe₂O₃ or FeO: 15-25%
CaO: about 10-20%
other species such as MgO: remainder to 100%.

The basicity index B of this slag, i.e. the mass ratio (CaO+MgO+Fe₂O₃)/(SiO₂+Al₂O₃) was typically about 0.6. The mass ratio CaO/SiO₂ was about 0.4.

The corrosion indicator (Ic) is equal, for a given section of the immersed part of the specimen, to the ratio of the percentage of loss of surface of the specimen of the reference example to the percentage of loss of surface of the specimen of the example under consideration, multiplied by 100. Ic is thus 100 for the reference product and a value of greater than 100 indicates better corrosion resistance.

The penetration depth of CaO originating from the slag is measured by means of a microprobe produced on a metallographic sector. The penetration indicator (Ip) is equal to the ratio of the penetrated depth of the specimen of the reference example to the penetrated depth of the specimen of the example under consideration, multiplied by 100. Ip is thus 100 for the reference product and a value of greater than 100 indicates better resistance to penetration of the slag.

Table 1 below summarizes the results obtained.

TABLE 1

| No. | | | | | | | | |
|---|---|---|---|---|---|---|---|---|
| 1 | 2 | 3 | 4 | 5 | 6 | 7 | 8 | 9 |

Elements of the feedstock

| | | | | | | | | | |
|---|---|---|---|---|---|---|---|---|---|
| G1 | 74.5 | | | 32.9 | 72.7 | 72.5 | 72.8 | 32.0 | 72.8 |
| G2 | | 82.8 | | | | | | | |
| G3 | | | 75.5 | | | | | | |
| G4 | | | | 43.4 | | | | 42.3 | |
| P1 | 14.7 | 9.9 | 14.1 | 13.7 | | | | | |
| P2 | 6.9 | 4.6 | 6.6 | 6.4 | 6.7 | | 6.7 | | 6.7 |
| P3 | 1.9 | 1.3 | 1.9 | 1.8 | 1.9 | 1.9 | 1.9 | 1.8 | 1.9 |
| P4 | | | | | 4.2 | 4.2 | 2.0 | 3.9 | 4.2 |
| P5a | | | | | | 7.1 | | 6.6 | |
| P5b | | | | | 12.5 | 12.4 | 14.7 | 11.6 | |
| P5c | | | | | | | | | 12.5 |

Chemical analysis of the sintered product
(measured, as a mass percentage)

| | | | | | | | | | |
|---|---|---|---|---|---|---|---|---|---|
| Cr₂O₃ | 87.1 | 12.3 | 13.3 | 51.0 | 71.0 | 71.2 | 71.3 | 32.1 | 71.9 |
| ZrO₂ | 6.2 | 19.4 | 13.9 | 37.7 | 18.1 | 18.1 | 19.7 | 51.7 | 17.2 |
| HfO₂ | 0.2 | 61.9 | 30.1 | 4.7 | 4.3 | 4.1 | 2.4 | 8.6 | 4.4 |
| SiO₂ | 0.9 | 0.7 | 1.0 | 0.9 | 1.0 | 0.9 | 1.0 | 1.0 | 0.8 |
| Al₂O₃ | 1.9 | 1.9 | 39.2 | 2.8 | 3.1 | 2.9 | 2.7 | 2.6 | 1.4 |
| CaO | 0.5 | 0.3 | 0.3 | 0.4 | 0.3 | 0.1 | 0.3 | 0.1 | 0.4 |
| MgO | / | 3.1 | 1.5 | 1.5 | 0.2 | 0.1 | 0.1 | 1.9 | 0.2 |
| TiO₂ | 1.6 | 0.4 | 0.3 | 0.8 | 1.3 | 1.3 | 1.6 | 0.8 | 1.6 |
| Y₂O₃ | / | / | / | / | 0.8 | 1.1 | 0.9 | 0.1 | 0.7 |

Other properties of the sintered product (before corrosion)

| | | | | | | | | | |
|---|---|---|---|---|---|---|---|---|---|
| Apparent | 4.3 | 6.2 | 4.4 | 4.5 | 4.4 | 4.4 | 4.2 | 4.5 | 4.3 |
| density | | | | | | | | | |
| (g/cm³) | | | | | | | | | |
| Open | 10.4 | 18.2 | 15.7 | 13.3 | 15.1 | 14.0 | 17.0 | 16.6 | 16.0 |
| porosity | | | | | | | | | |
| (%) | | | | | | | | | |

Resistance to heat shocks

| | | | | | | | | | |
|---|---|---|---|---|---|---|---|---|---|
| MOR res | 10 | 11 | 11 | 14 | 22 | 21 | 22 | 17 | 16 |
| (MPa) | | | | | | | | | |
| Δ MOR | −74 | −36 | −67 | −34 | −33 | −38 | −33 | −25 | −50 |
| (%) | | | | | | | | | |

Measurement of the corrosion resistance

| | | | | | | | | | |
|---|---|---|---|---|---|---|---|---|---|
| Ic | 100 | 400 | 90 | 108 | 90 | 93 | 102 | 93 | 109 |

Measurement of the resistance to
corrosion-induced penetration of CaO

| | | | | | | | | | |
|---|---|---|---|---|---|---|---|---|---|
| Ip | 100 | 175 | 160 | 111 | 170 | 937 | 103 | 256 | 124 |

Product No. 1 is the reference product.

Table 1 confirms that the presence of hafnium oxide and a high content of Cr₂O₃+HfO₂+ZrO₂ make it possible to improve the heat shock resistance. It also shows that the presence of hafnium oxide makes it possible to conserve or even to improve the corrosion resistance (index Ic). As is now clearly seen, the refractory product according to the invention advantageously makes it possible to improve the heat shock resistance, by maintaining good resistance to corrosion by the slags encountered in gasifier reactors.

It is also observed that the addition of zirconium oxide doped with yttrium oxide may have a favorable effect on the slag penetration resistance (Ip).

Needless to say, the present invention is not limited to the embodiments described, which are given as nonlimiting illustrative examples.

In particular, the application of the sintered refractory product according to the invention is not limited to a gasifier.

1. A sintered refractory product comprising, as mass percentages on the basis of the oxides,
more than 10% chromium oxide Cr₂O₃,
more than 2% hafnium oxide HfO₂,
more than 1% zirconium oxide ZrO₂,
the total content of chromium, hafnium and zirconium oxides Cr₂O₃+HfO₂+ZrO₂ being greater than 70%.

2. The refractory product as claimed in claim 1, in which the content of hafnium oxide HfO₂ is greater than 3%, as a mass percentage on the basis of the oxides.

3. The refractory product as claimed in claim 1, in which the content of hafnium oxide HfO₂ is less than 10%, as a mass percentage on the basis of the oxides.

4. The refractory product as claimed in claim 1, in which the content of chromium oxide Cr₂O₃ is greater than 30%, as a mass percentage on the basis of the oxides.

5. The refractory product as claimed in claim 4, in which the content of chromium oxide Cr₂O₃ is greater than 50% as a mass percentage on the basis of the oxides.

6. The refractory product as claimed in claim 1, in which the content of zirconium oxide ZrO₂ is greater than 10%, as a mass percentage on the basis of the oxides.

7. The refractory product as claimed in claim 6, in which the content of zirconium oxide ZrO₂ is greater than 30%, as a mass percentage on the basis of the oxides.

8. The refractory product as claimed in claim 1, in which at least 20% by mass of said zirconium oxide ZrO₂ is stabilized in cubic and/or quadratic form.

9. The refractory product as claimed in claim 8, in which at least 60% by mass of the zirconium oxide is stabilized in cubic and/or quadratic form.

10. The refractory product as claimed in claim 1, in which the total content of chromium, hafnium and zirconium oxides Cr₂O₃+HfO₂+ZrO₂ is greater than 85%, as a mass percentage on the basis of the oxides.

11. The refractory product as claimed in claim 1, comprising more than 0.5% of a dopant, optionally acting as a stabilizer for the zirconium oxide, chosen from CaO, MgO, Y₂O₃, TiO₂, and mixtures thereof, as a mass percentage on the basis of the oxides.

12. The refractory product as claimed in claim 11, in which the content of yttrium oxide is greater than 0.5%, as a mass percentage on the basis of the oxides.

13. The refractory product as claimed in claim 1, comprising a content of aluminum oxide Al₂O₃ of greater than 1% and less than 10% and/or a content of silica of greater than 0.5% and less than 3%, as mass percentages on the basis of the oxides.

14. The refractory product as claimed in claim 1, the structure of which has a granulate consisting, for more than 90% of its mass, of chromium oxide, the granulate being bound by a matrix consisting, for more than 90% of its mass, of zirconium oxide, hafnium oxide and optionally a dopant chosen from CaO, MgO, Y₂O₃ and TiO₂, the dopant optionally acting as a stabilizer for the zirconium oxide.

15. The refractory product as claimed in claim 1, the structure of which has a granulate consisting, for more than 90% of its mass, of zirconium oxide, hafnium oxide and chromium oxide, the granulate being bound by a matrix consisting, for more than 90% of its mass, of zirconium oxide and optionally of hafnium oxide and optionally of a dopant chosen from CaO, MgO, Y₂O₃ and TiO₂, the dopant optionally acting as a stabilizer for the zirconium oxide.

16. The refractory product as claimed in claim 1, in which the only zirconium oxide present in the matrix represents more than 2.5% of the total mass of the product.

17. The refractory product as claimed in claim 1, in which more than 50% of the hafnium oxide of the product is contained in the matrix, as a mass percentage.

18. The refractory product as claimed in claim 1, in which the content of yttrium oxide is less than 3%, as a mass percentage on the basis of the oxides.

19. The refractory product as claimed in claim 1, in which the sum of the contents of chromium oxide Cr₂O₃, zirconium oxide ZrO₂, hafnium oxide HfO₂, aluminum oxide Al₂O₃, silicon oxide SiO₂, calcium oxide CaO, magnesium oxide MgO, yttrium oxide Y₂O₃ and titanium oxide TiO₂ is greater than 95%, as a mass percentage, the other constituents of the product being impurities.

20. A gasifier comprising a reactor provided with an inner wall which is at least partially coated with a refractory coating comprising a refractory product as claimed in claim 1.

21. The gasifier as claimed in claim 20, in which said refractory product is in the form of a layer or in the form of a block.
